(19) United States
(12) Patent Application Publication
(10) Pub. No.: US 2024/0394789 A1
(43) Pub. Date: Nov. 28, 2024

(54) AUCTION SYSTEM AND PLATFORM

(71) Applicant: Iconically, Inc., Wayne, NJ (US)

(72) Inventors: Donald Doane, Wayne, NJ (US); Grant M. Warner, Bowie, MD (US)

(21) Appl. No.: 18/671,634

(22) Filed: May 22, 2024

Related U.S. Application Data
(60) Provisional application No. 63/503,698, filed on May 22, 2023.

(51) Int. Cl. G06Q 30/08

(52) U.S. Cl. CPC G06Q 30/08

(57) ABSTRACT

A system, platform, and method for grey box or semi-sealed bid reverse best-value auctions through remote computer devices according to a set of predetermined rules, where the reverse auction includes sealed bids with the exception of the highest and lowest bids which are disclosed to all auction bidders along with the total number of auction bidders. The system assigns bidders random identification numbers and allows for the selection of one or more winning bidders by the buyer based on best-value and not solely lowest price. The platform is geared towards the auctioning of influencer marketing campaigns, but may be applied to similar categorically intangible auctionable items and concepts as well.

### CONTINUITY

This application is a non-provisional patent application of provisional patent application No. 63/503,698, filed on May 22, 2023, and priority is claimed thereto.

### FIELD OF THE PRESENT INVENTION

The present invention relates to the field of auction mechanisms, and more specifically relates to an online auction platform and system configured to facilitate the bidding on marketing opportunities by companies and brands to social media influencers for partnership opportunities to be enacted on their personal accounts.

### BACKGROUND OF THE PRESENT INVENTION

Social media influencer marketing campaigns involve an entity with a brand, agreeing to pay a fee to individuals who have relevant social media followings on one or more social media or content distribution platforms including, but not limited to, Instagram™, Tiktok™, Snapchat™, Facebook™, Youtube™, and Twitter™. In certain cases, marketplace platforms such as tapfluence (www.tapinfluence.com), awario (https://awario.com), and klear (https://klear.com) are used, which are directed to the influencer market to allow searches and analysis of databases of these influencers to ascertain many aspects of their profiles and followings. In other cases, the entity might establish contact with the individuals directly via the social media or content platform, or via a third-party representative such as a management agent. The entity then negotiates a fee rate with the influencers, to include, one or several times, the entity's product or service either as a mention in the text related to their post, in an image, a video or an audio post or upload.

In particular, a problem faced by both brands and influencers is the difficulty in determining a fair market rate for collaboration on campaigns. Fees are generally a function of campaign type, terms and timing, and can vary widely across influencers based on perceived value; even amongst those with similar follower counts and engagement rates. For brand campaigns, return on investment is generally a function of influencer fees and engagement; both of which are variable rates.

What is lacking is an online bidding marketplace, where brands act as buyers and influencers act as sellers and are joined seamlessly for the competitive awarding of campaigns through semi-sealed bid reverse best-value auctions. Brands will select one or more winning bids based on best-value, which may include determining factors such as alignment, budget and other criteria including social reach and engagement, and have access to view bidding influencers organized by their followings and/or engagement. Brands may also consider an influencer's reviews and view their portfolio of work, including posts sponsored by other brands, as part of their final selection process.

Reverse auctions are auctions in which the roles of buyer and seller are reversed. That is, in traditional auctions, buyers compete to obtain goods/services from a seller by offering increasingly higher prices. In a reverse auction, sellers compete to obtain business from a buyer (i.e., offering to provide the good/service sought by the buyer), and prices typically decrease as the sellers underbid each other. An objective of a reverse auction is to enable a buyer to solicit goods/services from a plurality of seller-bidders in order to minimize the cost of the buyer for the goods/services desired. In other words, the bidder-sellers compete with one another for the buyer's business by offering increasingly lower prices at which they will provide the goods/services. For the buyers, such reverse auctions facilitate access to new suppliers of goods/services, optimize price and maximize return on investment.

In sealed bid reverse auctions, the sellers and buyer are not privy to the values of any bids until the auction closes, which helps avoid various problems associated with open reverse auctions, most notably, indecent bidding activities. Unlike open reverse auctions (i.e., where two or three sellers may be sufficient to keep lowering the price of the auctioned subject as they try to underbid one another), in sealed bid reverse auctions, the sellers are unaware of what all other sellers are bidding. Therefore, the sellers will strategically submit bids they feel would be an appropriate amount for providing the desired goods/services without the benefit of knowing what any of the other sellers are bidding for the same goods/services.

A number of deficiencies are present with existing sealed bid reverse auctions. For example, the uncertainty associated with existing sealed bid reverse auctions may dissuade many sellers from even participating in these types of auctions, since they will not know how their bids compare to the bids of other sellers. Similarly, if the seller knows that only one winner will be selected without knowledge of how many other bidders there are, they may also be dissuaded from participating. Accordingly, existing sealed bid reverse auctions have a problem with attracting a sufficient number of bidders to ensure a buyer's likelihood of obtaining the lowest reasonable price for the requested good/service. Because the bids are sealed, the bidder-sellers have no incentive to resubmit lower bids based on other bids. Another deficiency with existing sealed bid reverse auctions is a fear of the sellers that they may significantly under-bid, then win the reverse auction, and be obligated to provide the auctioned good/service for too low a price.

From a buyer's standpoint, a low number of bids raises the question of whether or not the bids are a reasonable and fair price for the goods/services. Buyers desire a larger number of bidder-sellers, which are likely needed, to increase the probability of obtaining a sufficiently low, fair and reasonable bid. A buyer wants to obtain the auctioned subject at a low price, but also generally desires good quality of service and may pay more for better value. Therefore, a buyer does not want a winning seller who experiences “winner's remorse” for fear that the quality of the goods/services, and/or the safe delivery or provision thereof, will be inadequate if the winning seller realizes that he/she bid significantly below market value. In addition, the buyer is limited to selecting a single winner based on lowest-price as opposed to highest-value or taking advantage of the multiple competitive best-value bids that are produced as a result of the reverse auction. While all auctions provide inherent risk, these practical realities can diminish participation in existing sealed bid reverse auction, and by extension, their likelihood of success.

In an open reverse auction, since bidders are able to view other bid amounts, they may engage in illegitimate or unfair bidding practices. For example, once a buyer submits an on-line reverse auction request for an auctioned subject with the expectation of obtaining the auction subject for a lower price, two or more colluding bidders may unfairly or illegally preserve a high bid. Although a live reverse auction on-site does not allow a bidder to withdraw a bid, an open online reverse auction may allow bidders to withdraw bids at any time as a general or routine practice. Thus, two colluding people who place lower bids withdraw, allowing a third colluding bidder to win the reverse auction at a higher price, forcing the buyer to pay the artificially elevated price. Current on-line reverse auctions offer no effective solutions for this specific on-line or internet-centric auction problem.

Thus, there is a need for a new auction system and platform which overcomes these deficiencies by offering a semi-sealed bid reverse best-value auction platform that offers a fair bidding and selection process. Such an improved system and method encourages more present and future participation in online semi-sealed bid reverse best-value auctions, and provides consumers with the ability to obtain high-value goods and/or services at the most desirable possible prices through a fair and reasonable process.

### SUMMARY OF THE INVENTION

The present invention relates generally to methods and systems for conducting an online semi-sealed bid reverse best-value auction for goods and/or services. The system and method also preferably uses the values of the highest and lowest bids to anchor future bid amounts for the auctioned goods/services. Generally, the methods and systems for remotely conducting a semi-sealed bid reverse best-value online auction in accordance with the invention have at least the following objectives:

To mitigate the risks to a buyer and a bidder in a semi-sealed bid reverse best-value online auction, or to help optimize the interests of the buyer or the bidder in such auctions.

To offer options for the buyer, bidders, or third-parties to customize the auction through various predetermined rules, settings, values, etc.

To provide incentives for both bidder and buyer participation by reducing uncertainty, encouraging lower bids, reducing “winner's remorse”, increasing the likelihood of fair and reasonable final bid amounts in accordance with one or more predetermined rules.

To establish multiple criteria by which bidders are recommended to a buyer for selection as auction winners according to the different predetermined rules and settings.

To enable a bidder to withdraw a bid before a close of the auction and submit a new sealed bid after withdrawing her/his bid before the close of the auction, and to enable a plurality of bidders to submit new sealed bids within a certain time frame when notified of a lower minimum bid amount.

To establish a ranking based on best-value, before a start of the auction, by a buyer, the system, a third-party, or by default, corresponding to which of a plurality of sealed bids received will be selected as the winning bids.

To provide an online reverse auction utilizing an open (i.e., visible) or hidden (i.e., closed or not visible) reserve price as determined by the buyer as the most the buyer is willing to provide for the auction subject.

To identify one or more bids for selection by a buyer as winning bids, and utilize a reserve price established by a buyer to aid in arriving at such selection.

To enable the auction to be cancelled, provide a buyer with an option to buy the auction subject for an amount above the reserve price, or provide a winning bidder with an option to sell an auction subject at a reserve price pre-set by the buyer if the submitted bids all exceed the reserve price.

In one aspect of the invention, a computer-implemented system for conducting a semi-sealed bid reverse best-value online auction is provided, which includes a computing system having one or more processors configured to provide an online platform for remotely conducting a semi-sealed bid reverse best-value online auction, a buyer computing device, and at least one bidder computing device. The buyer computing device and the at least one bidder computing device are configured to communicate with the computing system over a network. The system further includes one or more non-transitory computer readable program storage medium capable of storing instructions to instruct the processors to perform the auction in accordance with a set of predetermined rules. The one or more processors are configured to receive, from the buyer computing device, an auction request for an auction subject in the auction, and receive, from the bidder computing device, one or more sealed bids each specifying a bid amount for the auction subject. At least one of the sealed bids is a bid associated with the minimum and maximum bids for the auction and disclosed to the plurality of bidders.

The processors are further configured to assign an anonymous identifier to each of the sealed bids automatically, and to transmit, during the auction, to one or more bidder computing devices, a first representation of the auction including one or more of the anonymous identifiers. The first representation does not include the bid amount unless that amount is associated with the minimum and maximum bids for the auction, and the bidder computing device displays at least a portion of information related to the first representation.

The processors are also configured to recommend the best-value bids that will provide the maximum return on investment from the received sealed bids for final selection as winners by the buyer. The buyer will determine the winning bidders based on several best-value criteria, including alignment, engagement and budget; not solely on lowest bid price.

In another aspect of the invention, a computer-implemented method for conducting a semi-sealed bid reverse best-value online auction is provided. The method includes receiving, from a remote buyer computing device, an auction request for an auction subject in a semi-sealed bid reverse best-value online auction; and receiving, from at least one remote bidder computing device, one or more sealed bids specifying a bid amount for the auction subject. At least one of the sealed bids are minimum and maximum bids for the auction that are disclosed to the plurality of bidders along with the total number of bidders. Buyers provide a commitment to select one or more winners in accordance with a set of predetermined rules. The remote buyer computing device and the remote bidder computing device is configured to communicate over a network with a computing system having one or more processors. The method further includes assigning an anonymous identifier to each of the sealed bids automatically; transmitting, during the auction, to one or more of the remote bidder computing device, a first representation of the auction including one or more of the anonymous identifiers, but not including the bid amount unless that amount is associated with the minimum and maximum bids for the auction. The bidder computing device displays at least a portion of information related to the first representation. After the closing of the auction, the first representation may be disclosed to the plurality of bidders with the winning bids being highlighted after being selected by the buyer.

The method also includes determining, by the processors, the best-value bids from the submitted bids for final selection of the winners by the buyer; after the closing of the auction, a second representation including the final winning bid amounts associated with the winning bids corresponding to at least one of the anonymous identifiers to at least one remote bidder computing device for display of at least a portion of information related to the second representation.

Other objects, features, and characteristics of the present invention, as well as the methods of operation and functions of the related structural elements, and the combination of parts and economies of development and manufacture, will become more apparent upon consideration of the detailed description below with reference to the accompanying drawings, all of which form a part of this specification.

The following brief and detailed descriptions of the drawings are provided to explain possible embodiments of the present invention but are not provided to limit the scope of the present invention as expressed herein this summary section.

### BRIEF DESCRIPTION OF DRAWINGS OF THE PRESENT INVENTION

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1A shows a diagram of an example system for providing a grey box or semi-sealed bid reverse best-value online auction according to an exemplary embodiment of the invention;

FIG. 1B illustrates a database according to an exemplary embodiment of the invention;

FIG. 2 illustrates a data record for a semi-sealed bid according to an exemplary embodiment of the invention;

FIG. 3 depicts a computing device for use by either a buyer or a bidder according to an exemplary embodiment of the invention;

FIG. 4 depicts an alternative computing device for use by either a buyer or a bidder according to an exemplary embodiment of the invention;

FIG. 5A is a flowchart illustrating a bidding process from the bidder's side, in accordance with an exemplary embodiment of the invention;

FIG. 5B is a flowchart illustrating a continuation of the bidding process from the bidder's side shown in FIG. 5A;

FIG. 6A is a flowchart illustrating an auction process from the buyer's side, in accordance with an exemplary embodiment of the invention;

FIG. 6B is a flowchart illustrating a continuation of the auction process from the buyer's side shown in FIG. 6A; and

FIG. 7 is a flowchart illustrating a rate recommender algorithm of the present invention.

FIG. 8 depicts a flowchart detailing the backend processes of the creation of an auction on the system of the present invention.

### DETAILED DESCRIPTION OF THE PRESENT INVENTION

The present invention is a modular fence consisting of at least one module (10). Each of the at least one modules (10) includes boards (20) and posts (30). Additionally, each module (10) is preferably six feet tall by eight feet long (or six feet tall by six feet long). The at least one module (10) of the present invention, when properly erected, meets the Miami Dade County wind load requirement, the highest standard in America. As such, the at least one module (10) of the present invention is configured to withstand up to 115 MPH gusts and sustained winds of up to 75 mph.

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to affect such feature, structure, or characteristic in connection with other embodiments whether or not explicitly described.

The present invention is a computer-implemented system for conducting a semi-sealed bid, reverse best-value, online auction, which includes a computing system having one or more processors configured to provide an online platform for remotely conducting a semi-sealed bid reverse best-value online auction, a buyer computing device, and at least one bidder computing device. The buyer computing device and the at least one bidder computing device are configured to communicate with the computing system over a network. The system further includes one or more non-transitory computer readable program storage medium capable of storing instructions to instruct the processors to perform the auction in accordance with a set of predetermined rules. The one or more processors are configured to receive, from the buyer computing device, an auction request for an auction subject in the auction, and receive, from the bidder computing device, one or more sealed bids each specifying a bid amount for the auction subject. At least one of the sealed bids is a bid associated with the minimum and maximum bids for the auction and disclosed to the plurality of bidders.

The processors are further configured to assign an anonymous identifier to each of the sealed bids automatically, and to transmit, during the auction, to one or more bidder computing devices, a first representation of the auction including one or more of the anonymous identifiers. The first representation does not include the bid amount unless that amount is associated with the minimum and maximum bids for the auction, and the bidder computing device displays at least a portion of information related to the first representation.

The method also includes determining, by the processors, the best-value bids from the submitted bids for final selection of the winners by the buyer. The system will allow the buyer to select the winning bidders based on several best-value criteria; not necessarily solely on the lowest bid price. After the closing of the auction, a second representation including the final winning bid amounts associated with the winning bids corresponding to at least one of the anonymous identifiers to at least one remote bidder computing device for display of at least a portion of information related to the second representation.

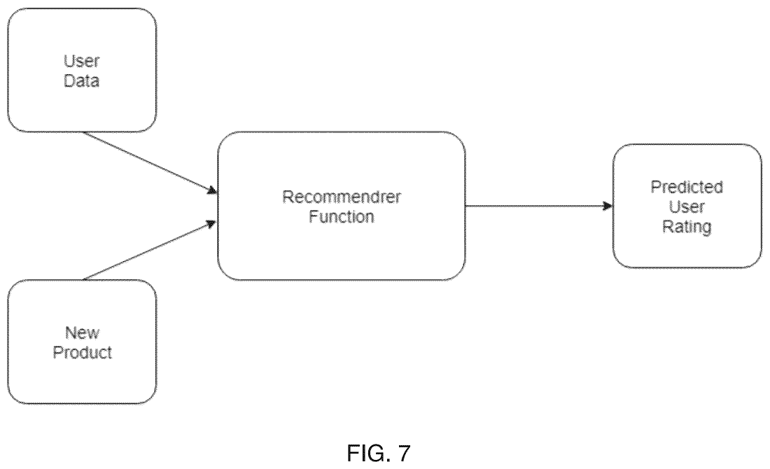

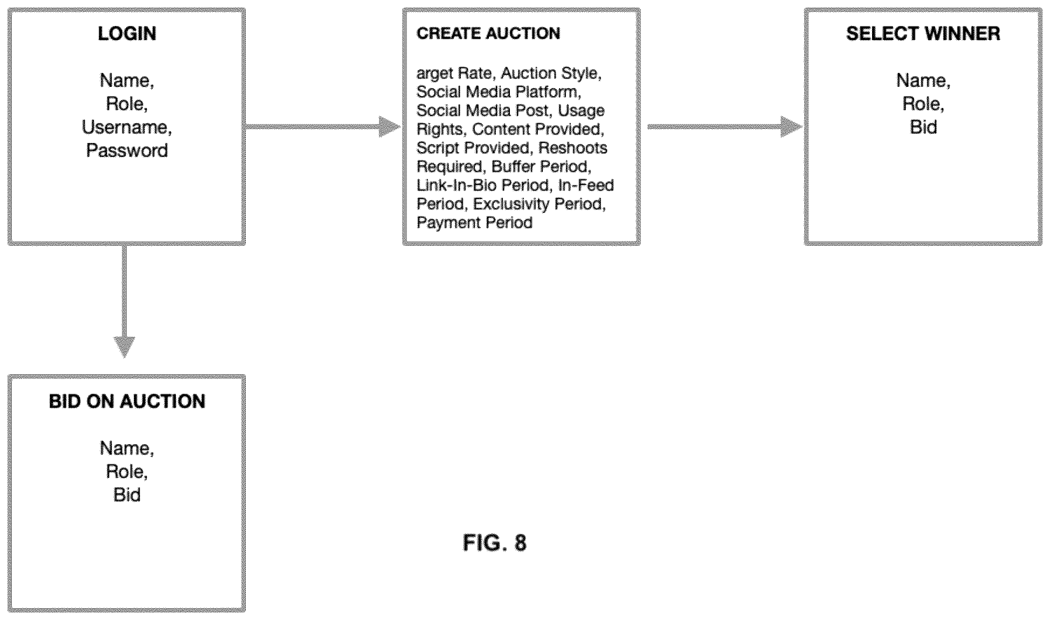

As depicted in FIG. 7, the platform of the present invention is preferably equipped with a rate recommender algorithm. This recommender system is a machine learning system that helps bidders offer competitive bids at a fair market value. An important component of the machine learning system is the recommender function, which takes information about the bidder and campaign, and predicts a rate or range of rates that the buyer is most likely to accept. Predicting rates, even before the bidder has actually provided one, makes the recommender system of the present invention a powerful tool. Relationships provide the recommender system with tremendous insight, as well as an understanding of bidders.

### Recommendation Engine Summary

The Iconically software platform of the present invention uses large language learning models (LLMs) to optimize the pairing of brands with social media influencers for product and service promotion by automatically recommending the following:

Input values for influencer marketing campaign auctions based on the likelihood of influencers to bid higher than the desired target rate or not at all, including, but not limited to the following form fields:
a. Target Rate-determine if selecting a particular rate to be recommended to influencers when bidding encourages influencers to bid more competitively based on bidding patterns of influencers from campaigns with the same selected values.
b. Auction Styles-determine if selecting multiple winners encourages influencers to bid more competitively based on bidding patterns of influencers from campaigns with single versus multiple winners.
c. Social Media Platforms-determine if selecting a particular social media platform encourages influencers to bid more competitively based on bidding patterns of influencers from campaigns with the same platforms selected.
d. Social Media Posts-determine if selecting a particular number of posts on a social media platform encourages influencers to bid more competitively based on bidding patterns of influencers from campaigns with the same selected values.
e. Usage Rights-determine if selecting a particular period of time that the original content influencers create can be reused encourages influencers to bid more competitively based on bidding patterns of influencers from campaigns with the same usage rights.
f. Content Provided-determine if providing content for influencers to post on their social media channels encourages influencers to bid more competitively based on bidding patterns of influencers from campaigns where content is also provided.
g. Script Provided-determine if providing a script for influencers to use in the creation of content on behalf of the brand encourages influencers to bid more competitively based on bidding patterns of influencers from campaigns where scripts are also provided.
h. Reshoots Required-determine if selecting a particular number of content re-edits by the brand encourages influencers to bid more competitively based on bidding patterns of influencers from campaigns with the same selected values.
i. Buffer Period-determine if selecting a particular period of time that influencers are required to wait before posting non-sponsored content encourages influencers to bid more competitively based on bidding patterns of influencers from campaigns with the same selected period.
j. Link-in-Bio Period-determine if selecting a particular period of time that influencers are required to keep sponsored links on their profile encourages influencers to bid more competitively based on bidding patterns of influencers from campaigns with the same selected period.
k. In-Feed Period-determine if selecting a particular period of time that influencers are required to keep sponsored content on their profile encourages influencers to bid more competitively based on bidding patterns of influencers from campaigns with the same selected period.
l. Exclusivity Period-determine if selecting a particular period of time that influencers are required to wait before posting other sponsored content encourages influencers to bid more competitively based on bidding patterns of influencers from campaigns with the same selected period.
m. Payment Period-determine if selecting a particular period of time that influencers are required to wait before receiving payment encourages influencers to bid more competitively based on bidding patterns of influencers from campaigns with the same selected period.

Input values for influencer marketing campaign auctions based on the likelihood of brands to accept the bid, including, but not limited to the following form fields:
a. Bidding Rate-determine if selecting a particular rate is more likely to be accepted by the brand based on acceptance patterns of brands for campaigns with the same selected values.

User profiles of influencers that are most likely to be interested in bidding on a particular influencer marketing campaign auction based on historical activity of the associated user account, including, but not limited to the following:
a. Login activity-determine how often the user logs into their account.
b. Profile activity-determine how often the user updates their account profile.
c. Bidding activity-determine how often the user bids on active campaign auctions.
d. Bidding similarity-determine how often the user bids on only campaign auctions with one or more matching influencer marketing campaign input field values.
e. Rating ranking-determine how the user ranks among other account profiles on the system.

It should be noted that the system algorithm is configured to determine an optimal bid from the previously received winning bids, and, upon the winning bid being associated with the current campaign auction: apply the set of predetermined rules based on the Ordinary Least Squares (OLS) method to the amount of the new winning bid to calculate the updated optimal price; determine a new recommended bid relative to all of the previous winning bids; compute a difference between the amount of the previous winning bids and the amount of the new winning bid; apply the set of predetermined rules to the difference to calculate an adjustment amount; computed, based on a closing of the auction and the winning bid being associated with the current campaign auction, a recalculated recommended bid amount based on a OLS formula applying at least one of the adjustment amounts to the amount of the previous recommended bid.

### Recommendation Engine Workflow

1. System allows for role-based authentication and user credentialing. This is typically initiated via a validated username and password presented upon login. A User registers a new account in the system via an online Web form or mobile application interface, which collects, at minimum, values for the NAME, ROLE, USERNAME and PASSWORD that are to be associated with the new account and stores this data in a USER table that is associated with a unique key.
2. Accounts assigned the role of brand are entitled to create campaign auctions via a form that is presented to the user immediately upon login. The User submits the form with USERNAME and PASSWORD. Then, the System attempts to look up matching credentials. If successful match is found and the user ROLE equals BRAND, then the system renders the “create campaign auction” form.
3. This form for creating campaign auctions allows the authenticated user to input and store values for later use in influencer marketing campaign auctions. These form inputs are typically stored in relational database tables. These tables include, but are not limited to: a Timestamp table with unique identifier and columns consisting of Target Rate, Auction Style, Social Media Platform, Social Media Post, Usage Rights, Content Provided, Script Provided, Reshoots Required, Buffer Period, Link-In-Bio Period, In-Feed Period, Exclusivity Period, Payment Period and any other relevant form fields.
4. The user selects the appropriate form values for each input field prior to submitting the form. The system may present the user with suggested or default form field values. The user may edit these values. The system may provide feedback on the edited inputs.
5. Upon each field selection, the system performs a lookup in the relevant database table to compare the current selected value to the calculated average or mean values for all previously completed campaign auctions that resulted in winning bids since the system was first initiated and dynamically displays feedback through the interface advising the user to adjust the value up or down in order to achieve an optimal selection. A machine based learning algorithm is applied to each data set that represents a unique auction. The algorithm compares values or coefficients for Target Rate, Auction Style, Social Media Platform, Social Media Post, Usage Rights, Content Provided, Script Provided, Reshoots Required, Buffer Period, Link-In-Bio Period, In-Feed Period, Exclusivity Period, Payment Period and any other relevant form fields across campaigns and attempts to solve for the optimal coefficient using the Ordinary Least Squares (OLS) method. The OLS method aims to minimize the sum of the squared differences between the observed values and the values predicted by the linear approximation. This is achieved by adjusting the coefficients of the linear model iteratively until the error is minimized.
6. Upon submission of the form, the system stores values for input fields consisting of Target Rate, Auction Style, Social Media Platform, Social Media Post, Usage Rights, Content Provided, Script Provided, Reshoots Required, Buffer Period, Link-In-Bio Period, In-Feed Period, Exclusivity Period, Payment Period and any other relevant form fields. These values are linked in the database table by a unique identifier that serves as a reference for the campaign auction. Timestamp table with unique identifier and columns consisting of Target Rate, Auction Style, Social Media Platform, Social Media Post, Usage Rights, Content Provided, Script Provided, Reshoots Required, Buffer Period, Link-In-Bio Period, In-Feed Period, Exclusivity Period, Payment Period and any other relevant form fields.
7. Accounts assigned the role of influencer are entitled to bid on campaign auctions via a form that is presented to the user immediately upon login. The User submits form with USERNAME and PASSWORD. System attempts to look up matching credentials. If successful match is found and the user ROLE equals INFLUENCER, then the system renders the auction bid form.
8. This form for bidding on campaign auctions allows the authenticated user to input and store values for later use in influencer marketing campaign auctions. These form inputs are typically stored in relational database tables (namely the Timestamp table with unique identifier and columns consisting of Bidding Rate and any other relevant form fields).
9. The user selects the appropriate form values for each input field prior to submitting the form. The system may present the user with suggested or default form field values. The user may edit these values. The system may provide feedback on the edited inputs.
10. Upon each field selection, the system performs a lookup in the relevant database table to compare the current selected value to the calculated average or mean values for all previously completed campaign auctions that resulted in winning bids since the system was first initiated and dynamically displays feedback through the interface advising the user to adjust the value up or down in order to achieve an optimal selection. A machine based learning algorithm is applied to each data set that represents a unique auction. The algorithm compares values or coefficients for Bidding Rate and any other relevant form fields across campaigns and attempts to solve for the optimal coefficient using the Ordinary Least Squares (OLS) method. The OLS method aims to minimize the sum of the squared differences between the observed values and the values predicted by the linear approximation. This is achieved by adjusting the coefficients of the linear model iteratively until the error is minimized.
11. Upon submission of the form, the system stores values for input fields consisting of Bidding Rate, and any other relevant form fields. These values are linked in the database table by a unique identifier that serves as a reference for the campaign auction. (in a Timestamp table with unique identifier and columns consisting of Bidding Rate and any other relevant form fields).
12. Accounts assigned the role of brand are entitled to select winning bids for campaign auctions via a form that is made accessible to the user via menu links. Winning bids are linked in the database table by a unique identifier that serves as a reference for the campaign auction. (In a Timestamp table with unique identifier and columns consisting of Winning Bid and any other relevant form fields.)
13. The system identifies influencers that are most likely to be interested in bidding on a campaign auction by querying historical activity of the associated user account, including system table data for Login, Profile, Bidding and Rating activity.
There are three main types that occur for the recommender model of the present invention:

### Bidder-Campaign Relationship

The bidder-campaign relationship occurs when some bidders have an affinity or preference towards specific campaigns. For example, a celebrity influencer might have a preference for non-profit campaigns and bid a lower than typical rate, thus the system will build a bidder-campaign relation of influencer->nonprofit along with discounted rate.

### Campaign-Campaign Relationship

Campaign-campaign relationships occur when marketing briefs, or requirements, are similar in nature. Some examples include campaigns that cover annual events such as Black History Month or Black Friday. The system will take into account the type and time of the campaign for comparison purposes.

### Bidder-Bidder Relationship

Bidder-bidder relationships occur when some influencers have similar following and engagement rate bands. Examples include micro-influencers with followings of 10,000-20,000 people and engagement rates of 5-7.5%. The system will use these bands to group influencers along with their corresponding bid rates.

### Campaign-Bidder Relationship

The campaign-bidder relationship occurs when some campaigns have an affinity or preference towards specific bidders. For example, a campaign might have a preference for influencers with particular attributes and behaviors, this could include audience size, tone of posts (humor, etc.), prior campaign experience, etc. The system will use prior behavior of campaign managers to guide bid suggestions.

In addition to relationships, the recommender system utilizes the following kinds of data:

### Bidder Behavior Data

Bidder behavior data is useful information about the engagement of the bidder with the auction. It can be collected from clicks and bidding history.

### Bidder Demographic Data

Bidder demographic information is related to the bidder's social following information such as the age, gender and location of followers.

### Campaign Attribute Data

Campaign attribute data is information related to the campaign itself such as target audience, start date, and call-to-action.

The system for semi-sealed bid reverse best-value auctions is preferably housed on a remotely hosted server capable of executing application code and communicating with an external database. The application code executes the algorithm described herein and the database contains a detailed list of attributes for buyers, bidders and campaigns.

The platform of the present invention preferably uses an AI/ML algorithm to provide suggested rate data in real-time to brands and influencers participating in time-limited auctions based on current and previously awarded bids for similar campaigns, and the time of day, month and year of those bids. The AI/ML inference engine looks at company characteristics, influencer attributes and campaign requirements to recommend rates.

The system allows for brands to create company profiles with multiple attributes including number of employees, annual revenues, etc.

The systems allows for influencers to create profiles with multiple attributes including number of followers, engagement rate, etc.

The system allows for brands to create campaigns with multiple attributes including number and type of required posts.

The system allows for influencers to bid their best rate on those campaigns.

The system automatically discovers campaigns that strongly or weakly match the current campaign created by the brand.

The system automatically discovers influencers that strongly or weakly match the profile of the bidder.

The system automatically discovers winners of the matching campaigns and recommends rates that strongly or weakly match current bidders to both the bidders and brands.

The system allows for rating and reviews of both brands and influencers by winning bidders.

The system allows for providing bid data to third-party auction platforms and systems.

Buyers and bidders must first register accounts on the system by using a remote computer or other hand-held device to access and complete an online registration form. The registration form includes at least field inputs for the name and email. The data submitted from the form is stored in a database. Once registered, the user may login to either create campaigns or bid on new campaigns.

Buyers and bidders initially register an account with the system that is verified before being permitted to submit campaigns or bids. Registering buyers bidders may be required to sign or otherwise agree to one or more user agreements outlining relevant rules preset for both buyers and bidders prior to the start of the auction.

During registration, the systems disclosed herein can require that a user provide personally identifiable information and valid financial information, including, for example, name, address, email, phone number, bank information, etc. User accounts can be verified by the system through email, text, and/or phone by the system administrator. The systems disclosed herein may allow users to only register one account by email, text, and/or phone with a username for bidding or for listing a request for an auctioned subject/service. An account may be used to either bid on or list a campaign.

The system uses a database to store and dynamically updates data related to the auction process, including but not limited to, detailed information regarding the campaign up for auction, transaction data (which may also contain data pertaining to previous transactions), bidding data (e.g., bid history, prices, timestamps, etc.), user data (e.g., user profiles, financial information, auction history, sealed winning bidder ID information, etc.), and other data (i.e., feedback from the buyer following completion of the campaign by the winning bidder for the buyer). Similarly, the database can maintain and dynamically update records on each buyer, including, for example, the buyer's budget size based on current as well as previously completed campaigns.

A buyer, or brand, logging in through the internet creates a new campaign on the system by filling in a campaign request form. The request form includes at least the start and end dates of the auction, the start and end dates of the campaign, and a detailed description of the campaign. This information is input by the buyer into the computing device of the buyer and stored by the system in a remote database.

A bidder, or influencer, logging in through the internet selects one or more campaigns displayed by the system to bid on. In addition to the campaign description, the system may show the bidder recommended rates in real-time from previously completed auctions or other data sources. The system may customize the display of recommended rates based on profile information collected from the bidder during registration, including number of social media followers and engagement ratings.

The system of the present invention may also disclose the highest and lowest competing bids that have been submitted by other bidders to the current bidder. The system may not disclose any other information collected from competing bidders during the registration process to the current bidder while the auction is in process. The system may disclose this information to the current buyer and/or competing buyers during or at the conclusion of the auction.

Once the auction closes, the system recommends one or more bids for selection by a buyer of one or more winning bids based on predetermined rules for the auction. The buyer must select at least one winner for the auction, but is not limited to the bidders recommended by the system. The winning bid amounts may be disclosed to the participants in the auction. The bid amounts may alternatively not be disclosed except for the winning bid amounts to the buyer.

The system next determines whether and which bidders are recommended to the buyer to win the auction. If a bidder wins the auction, then the winning bidder will be obligated to and agree to complete the campaign for the buyer for the bid amount submitted. The system may be configured to require a transaction to take place between the buyer and the winning bidders-sellers within a certain amount of time (e.g., within ten days of the end of the reverse auction).

After a winning bidder provides the auctioned subject to the buyer, the buyer pays the winning bidders their respective winning bid amounts. The buyer may be obligated to pay winning bidders before the winning bidders complete the campaign. In other embodiments, the buyer may be obligated to pay winning bidders only upon completion of the campaign. Payment may be exchanged in part or in full during these transactions depending on specific agreements of the parties, the particular auction, and/or user agreements.

Once the campaign has been completed and payment has been made, the parties may be provided with the option to rate each other through the system, and such ratings may be stored in database. The process concludes once ratings are received or after the parties decline to rate one another.

The platform of the present invention preferably uses an AI algorithm to provide suggested rate data in real-time to brands and influencers participating in time-limited auctions based on current and previously awarded bids for similar campaigns, and the time of day, month and year of those bids. AI inference engine looks at company characteristics, influencer attributes and campaign requirements to recommend rates.

The system allows for brands to create company profiles with multiple attributes including number of employees, annual revenues, etc.

The system allows for influencers to create profiles with multiple attributes including number of followers, engagement rate, etc.

The system allows for brands to create campaigns with multiple attributes including number and type of required posts.

The system allows for influencers to bid their best rate on those campaigns.

The system automatically discovers campaigns that strongly or weakly match the current campaign created by the brand.

The system automatically discovers influencers that strongly or weakly match the profile of the bidder.

The system automatically discovers winners of the matching campaigns and

recommends rates that strongly or weakly match current bidders to both the bidders and brands.

The system allows for rating and reviews of both brands and influencers by winning bidders.

The system allows for providing bid data to third-party auction platforms and systems.

### Rate Recommendation Engine

Uses AI algorithm to provide suggested rates to brands and influencers based on previously awarded bids for similar campaigns.

The system allows for brands to create company profiles with multiple attributes including number of employees, annual revenues, etc.

The systems allows for influencers to create profiles with multiple attributes including number of followers, engagement rate, etc.

The system allows for brands to create campaigns with multiple attributes including number and type of required posts.

The system allows for influencers to bid their best rate on those campaigns.

The system automatically discovers campaigns that strongly or weakly match the current campaign created by the brand.

The system automatically discovers influencers that strongly or weakly match the profile of the bidder.

The system automatically discovers winners of the matching campaigns and

recommends rates that strongly or weakly match current bidders to both the bidders and brands.

The system allows for brands to create company profiles with multiple attributes including number of employees, annual revenues, etc.

The systems allows for influencers to create profiles with multiple attributes including number of followers, engagement rate, etc.

The system allows for brands to create campaigns with multiple attributes including number and type of required posts.

The system allows for influencers to bid their best rate on those campaigns.

The system automatically discovers campaigns that strongly or weakly match the current campaign created by the brand.

The system automatically discovers influencers that strongly or weakly match the profile of the bidder.

The system automatically discovers winners of the matching campaigns and recommends rates that strongly or weakly match current bidders to both the bidders and brands.

Process of application of the system and platform of the present invention:
1. Brands sign-up for a subscription to access discounted rates through a creator community of members of the platform of the present invention.
2. When brands have an influencer marketing campaign, it is translated into an online brief for auction on the platform.
3. Creators are notified when campaign briefs go live and bid their best rates to win using the highest and lowest bid values to help anchor their bid submissions.
4. At the close of the auction, bidders are shortlisted by our system to help brands decide which bids to select as winners, including alignment, engagement and budget; not solely on lowest bid price
5. Winning bids are notified to accept the brief terms and get to work on the campaign.
6. The platform of the present invention manages payments, and stores final deliverables for easy review.

Exemplary embodiments of the invention provide a semi-sealed bid, buyer-held reverse online auction for a buyer and one or more bidders (i.e., sellers, bidder-sellers, etc.) in which the bidders compete for the buyer's business using a sustainably balanced system and method by which the buyer can acquire goods/services at a fair rate while allowing bidder-sellers to collect fair compensation for their goods/services. Generally, a buyer may include any individual, customer, entity or group thereof seeking to obtain goods/services temporarily or permanently. Accordingly, the system discloses the highest and lowest bids (also referred to herein as a “anchor bids”) along with the total number of auction bidders, and helps mitigate problems otherwise associated with “winner's remorse” or “winner's curse.” The invention can mitigate risk and help balance buyer/bidder interests. Alternatively, the system can be configured to help optimize the buyer or bidder interests.

In the semi-sealed bid, reverse auctions contemplated herein, the goods/services which the buyer ultimately seeks to retain or acquire can involve the permanent or temporary transfer of ownership or possession rights, and/or the transfer of goods and/or the provision of services. Possession rights, which relate to the control a person exercises over an auctioned subject, can be transferred from one party to another without transferring actual ownership. The transfer of possession rights requires an intention of one party to possess (e.g., temporarily) a property in exchange for monetary value.

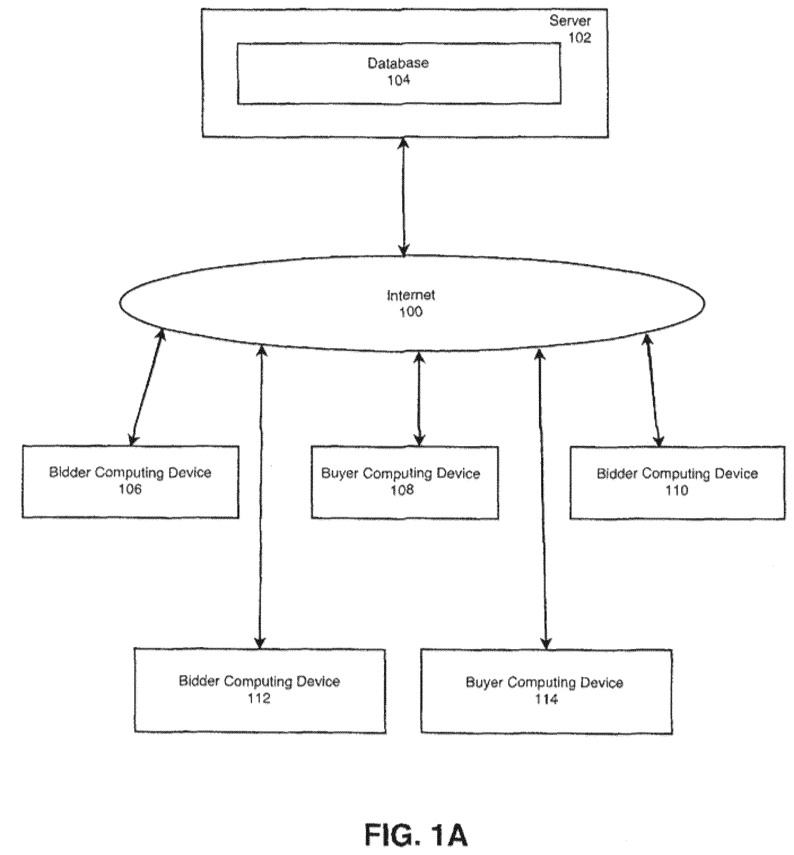

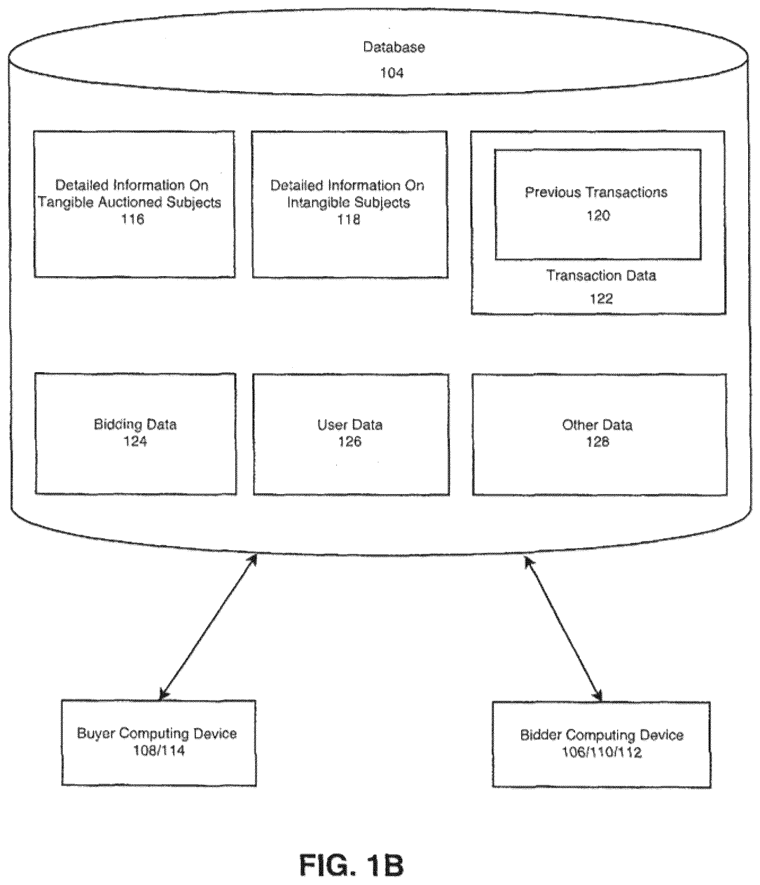

Turning now to FIG. 1A, illustrated is a diagram of an example system for providing a semi-sealed bid reverse best-value online auction according to an exemplary embodiment of the invention. As shown, server 102 is in communication with at least one of a plurality of buyers at remote buyer computing device 108/114 and at least one of a plurality of registered bidders at remote bidder computing device 106/110/112 through a communication network (e.g., Internet 100). Server 102 is preferably configured to receive a reverse auction request for an auctioned subject from buyer computing devices 108/114 and store it in one or more databases 104, which may include a unified database, a remote data center, a cloud-based data storage medium, a portable database, a relational database, or the like. Each reverse auction request received preferably includes at least a description of the auctioned subject and a time duration for the reverse auction input by the buyer into buyer computing device 108/114. The reverse auction request can also include a start price (start auction price) and/or a reserve price.

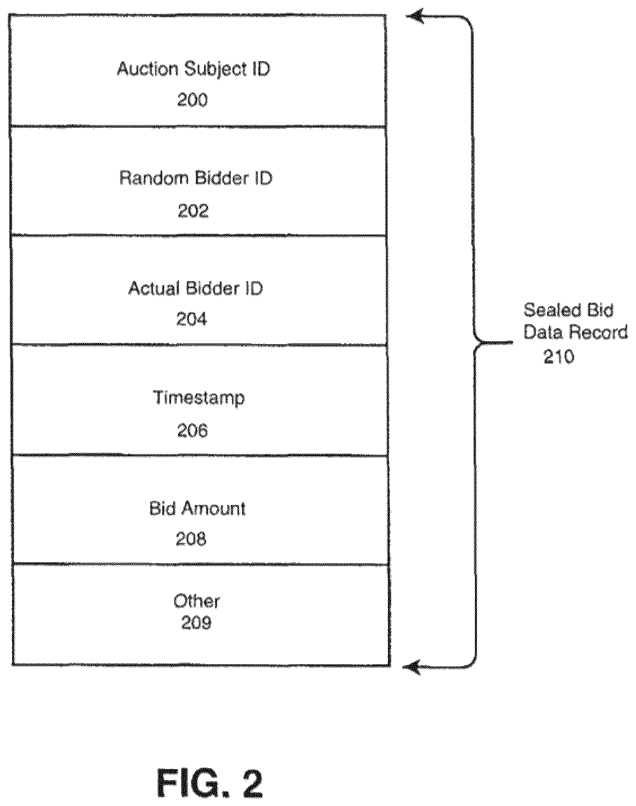

Server 102 is preferably configured to conduct a reverse auction based on the auction request of the buyer with a plurality of registered bidder-sellers using remote bidder computing devices 106/110/112. As shown in FIG. 2, at least one sealed bid may be input into bidder computing device 106/110/112 during the time duration or timeframe of the reverse auction, which is then communicated to server 102. The sealed bid can include, for example, auction ID or auction subject ID 200, bid amount 208 for the auctioned subject, random bidder ID 202, for example, randomly assigned by server 102 to each of the sealed bids received through bidder computing devices 106/110/112 during the auction, and data record 210 for each of the sealed bids stored in database 104 on server 102. Sealed bid data record 210 may contain at least auction ID or auction subject ID 200, random bidder ID 202, actual bidder ID 204, timestamp 206, bid amount 208, and other pertinent information 209 relating to the bidder. A system computing device in operative communication with server 102, at least one of a plurality of registered buyers, and at least one of a plurality of registered bidder-sellers through server 102 via a communication network (e.g., Internet 100) preferably recommends one or more bids to the buyer for final selection of one or more winning bids by the buyer at the end of the auction (i.e., at the close of the auction) in accordance with data record 210 received for each of sealed bids 200. The buyer must choose at least one bid as the winner and is not restricted to choosing from the bids recommended by the system.

The buyers and bidders discussed herein who use the buyer and bidding computing devices can include various types of users, such as, for example, individuals, business entities, not-for-profit organizations, or government agents. The systems disclosed herein integrate a means for maintaining one or more of database 104 to store buyer and bidder information without disclosing real identifications or information about auctioned tangible and/or intangible auctioned subjects. By way of example, as shown in FIG. 1B, database 104 preferably contains, stores and dynamically updates data related to the bidding process, including but not limited to, detailed information regarding tangible 116 or intangible 118 auctioned subjects, transaction data 122 (which may also contain data pertaining to previous transactions 120), bidding data 124 (e.g., bid history, prices, timestamps, etc.), user data 126 (e.g., user profiles, financial information, auction history, sealed winning bidder ID information, etc.), and other data 128 (i.e., feedback from the buyer following receipt of the good/service from the bidder to the buyer). Similarly, database 104 can maintain and dynamically update records on each buyer, including, for example, the buyer's ability to pay the amount owed for the good/service provided by the bidder, along with any applicable shipping costs, insurance, etc.

In a preferred embodiment, certain information about the auction subject and the bidders is kept hidden from the bidders during the reverse auction. Database 104 through, for example, a communication network and/or server-side computing device may be connected to and queried by buyers from remote buyer computing devices 108/114 and by bidders from remote bidder computing devices 106/110/112 to obtain relevant information such as references about historical transactions and prices of goods and services relating to the auctioned subjects. Historical transactions within database 104 may provide, for example, a price reference relating to at least one of the plurality of registered bidders or the plurality of registered buyers about at least one previously auctioned subject of value in case the bidders lack sufficient knowledge and experience about the services or products they intend to offer for sale as the auction subject. With respect to buyers, access to such historical transactions may be helpful for listing reserve prices within the reverse auctions. Database 104 may be queried for searches by at least one of the plurality of registered bidders or the plurality of registered buyers about at least one previously auctioned subject of value without disclosing the actual bidder ID of the winning bidder. Each of the sealed bids may be securely stored on server 102 during the time duration of the reverse auction. At the end of the auction, bid amounts and timestamps can be displayed to the plurality of bidders without the actual bidder IDs being displayed.

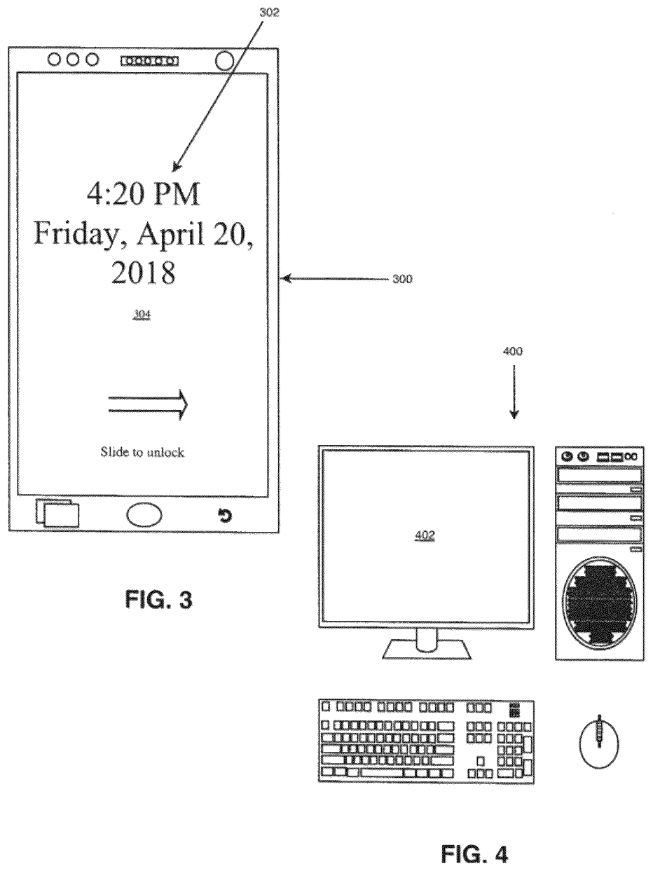

As shown in FIG. 3, bidder computing devices 106/110/112 or buyer computing devices 108/114 may be a user's smartphone or other “smart” handheld user device 300, and may have internal clock mechanism providing time and/or date information 302 that automatically identifies and communicates to server 102 timestamp data 206 for each sealed bid to determine and record the sequence of the submitted bids. Each user device 300 may also have display 304, and may be any computing device known in the art. By way of example, a smartphone, tablet, personal computer or any other computing device may be utilized. Alternatively, as shown in FIG. 4, each bidder computing devices 106/110/112 or buyer computing devices 108/114 may be user device 400 such as a personal computer having display 402. User device 400 may be any computing device known in the art, such as, for example, a personal desktop computer, a laptop, a tablet, a smart TV, a gaming system, in-vehicle computer or navigation system, or any other computing device.

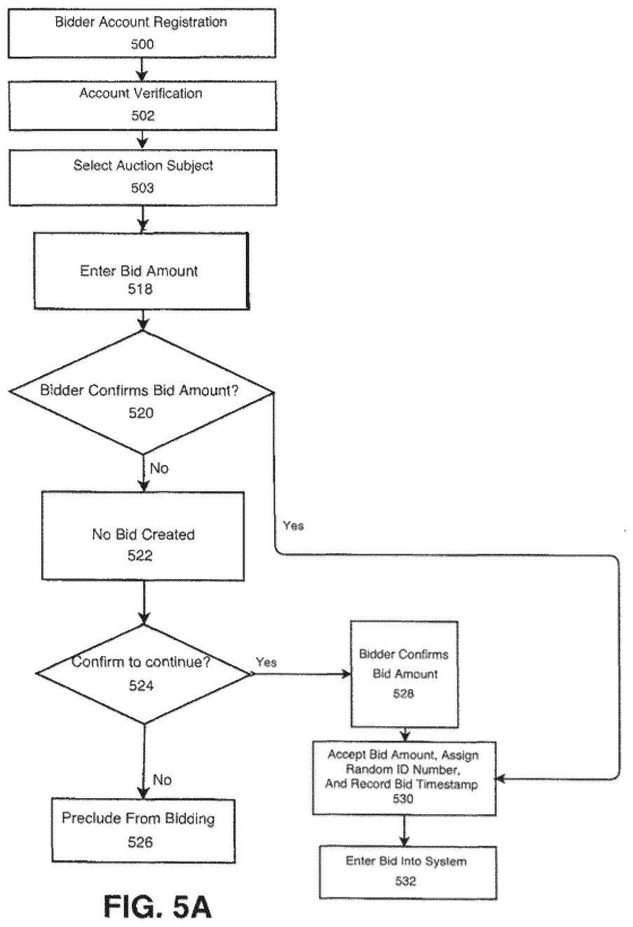

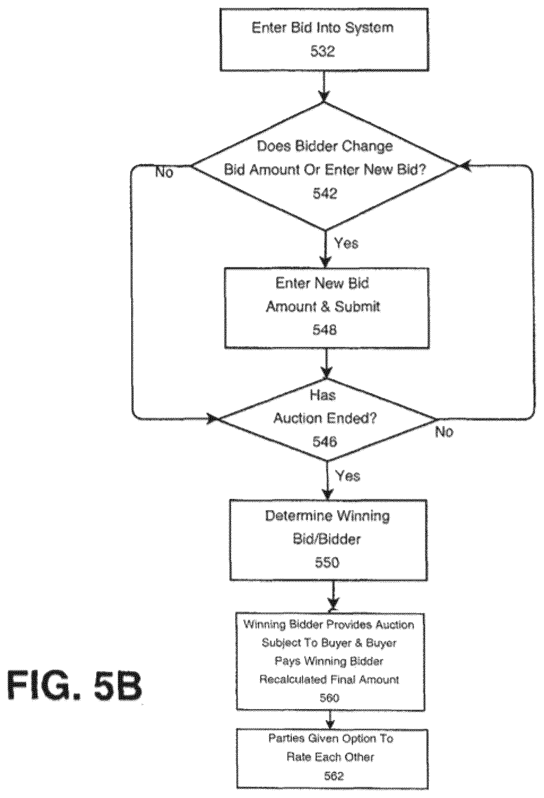

Referring next to FIG. 5A, shown is a flowchart depicting a bidding process from the bidder's side, in accordance with an exemplary embodiment of the invention. As shown, bidders initially register an account with the system (Step 500) that is verified (Step 502) before being permitted to submit bids for a reverse auction. Registering bidders may be required to sign or otherwise agree to one or more user agreements outlining relevant rules preset for both buyers and bidders prior to the start of the reverse auction. During registration, the systems disclosed herein can require that a user provide personally identifiable information and valid financial information, including, for example, name, address, email, phone number, bank information, etc. User accounts can be verified by the system through email, text, and/or phone by the system administrator. The systems disclosed herein may allow users to only register one account by email, text, and/or phone with a username for bidding or for listing a request for an auctioned subject/service. An account may be used to either bid on or list a reverse auction.

To begin an auction, registered bidders must select an auction subject (Step 503) to bid on. As used herein, the term “winning bid amount” is an amount of the final bid submitted by a winning bidder of the auction.

A bidder may begin bidding by entering a bid amount (Step 518). The bidder then preferably provides double confirmation that the bid amount is accurate and confirm the bidder's ability to provide the auction subject for the amount of the bid (Step 520). If the bidder does not confirm either the bid amount or the ability to provide the auction subject for the amount of the bid (No, Step 520), then the bidder is notified by the system that no bid has been created or allowed (Step 522). The bidder may choose to change the bid amount and continue (Yes, Step 524) by confirming the bid amount and ability to provide the auction subject at the bid amount (Step 528). If the bidder still chooses to not confirm (No, Step 524), then the bidder is precluded from bidding (Step 526). If the bidder confirms (Step 528) or (Step 520), then the bid amount is accepted and the bidder is assigned a random ID number and the system records a timestamp for the bid (Step 530). The bid is then entered into the system and stored in the database (Step 532).

While double confirmation is provided by the system to serve as a better practice purpose for the auction, an auction may still proceed without the double confirmation. Once the bid is double-confirmed and stored in the database of the system, the system can accept the submitted bid amount and enter it for the reverse auction within the bidding system (Step 532), and seal the bidder's ID. Bidders may be listed or displayed in the order in which they bid using randomly generated anonymous ID numbers by the system. The bidders' identities and respective bids and bid amounts are not accessible to other bidders (except for the highest and lowest bid amounts, and, potentially, the bidders' anonymous randomly generated ID numbers), even after the reverse auction closes. That is, the accepted bid amounts are sealed, and each bidder and bid amount is assigned a random identification number and identified with a timestamp to track status of the bid and indicate when it was accepted by the system (Step 530). Users may be allowed to see the applicable remaining time for the reverse auction regardless of where they are located. However, the system may enable the buyer to view the real identification of the winning bidders. In other embodiments, the system can be configured to allow all bidders to see the bid or amounts of other bidders after the auction ends with or without seeing the bidders' real identifications.

Turning now to FIG. 5B, shown is a flowchart depicting a continuation of the bidding process shown in FIG. 5A. As shown, after the bid has been entered into the system (Step 532), a bidder may change the submitted bid amount before the reverse auction closes or ends (Step 542). However, in preferred embodiments, every bidder is allowed to submit only one final valid bid. If the bidder does not change her/his submitted bid (No, Step 542), then the system determines the submitted bid to be the valid bid for that bidder. If the bidder decides to change her/his submitted bid (Yes, Step 542), then the bidder may enter a new bid amount, and submit it to the system (Step 548). In preferred embodiments, if a bidder submits a new bid or otherwise re-submits a bid, then any previously submitted bids by that bidder are replaced. In this way, each bidder may only have one pending valid bid for an auction subject. In alternative embodiments, the system may determine only the most recent bid to be the valid bid, or may alternatively select the lowest bid to be the valid bid, depending on the predetermined rules for the auction. If the bidder does not change the bid again, then the system will determine the re-entered submitted bid to be the only valid bid by that bidder.

In alternative embodiments, the system may be configured to allow a bidder to change her/his bid by raising, lowering, re-submitting a bid, and/or changing a bid amount before the close of the reverse auction. Bidders may also be allowed to withdraw their bids before the reverse auction closes. Withdrawn and/or changed bids may still remain sealed so others will not be aware of them with the exception of the highest and lowest bid values. By keeping withdrawn or changed bids confidential, the system can prevent bidders from using withdrawn and/or changed bids as additional reference points, and can eliminate or reduce misrepresentation or fraud. The system may continuously monitor the auction for any indications from bidder computing devices 106/110/112 that a bidder wants to change an existing bid (Step 542) up until the auction has closed or ended (Step 546). Upon expiration of the time frame for the reverse auction, the reverse auction will close or end (Step 546).

The system can be configured using computer-executable instructions, such as program modules, to transmit a first representation of the anonymous, semi-sealed bid reverse best-value online auction to at least one of remote bidder computing devices 106/110/112 during the reverse auction. The first representation preferably includes the highest and lowest bid amounts along with the total number of bidders, one or more different (or anonymous) identifiers relating to the status of the reverse auction (e.g., the randomly assigned ID numbers assigned to the bids/bidders, the number thereof, the timing thereof, and/or the time remaining in the reverse auction, etc.). Receipt of the first representation by the remote bidder computing devices may trigger or cause them to display at least a portion of the information related to the first representation.

Once the reverse auction closes, the system recommends one or more bids for selection by a buyer of one or more winning bids based on predetermined rules for the auction (Step 550), and the winning bid amounts may be disclosed to the participants of the reverse auction. The bid amounts may alternatively not be disclosed except for the winning bid amounts to the buyer.

The system next determines whether and which bidders are recommended to the buyer to win the reverse auction. If a bidder wins the reverse auction, then the winning bidder will be obligated to and agree to provide the auction subject to the buyer for the bid amount submitted. The system may be configured to require a transaction to take place between the buyer and the winning bidders-sellers within a certain amount of time (e.g., within ten days of the end of the reverse auction).

After a winning bidder provides the auctioned subject to the buyer, the buyer pays the winning bidders their respective winning bid amounts (Step 560). The buyer may be obligated to pay winning bidders before the winning bidders provide the auctioned subject. In other embodiments, the buyer may be obligated to pay winning bidders only after receipt of the auctioned subject. Payment may be exchanged in part or in full during these transactions depending on specific agreements of the parties, the particular reverse auction, and/or user agreements. Once the auctioned subject has been received and payment has been made, the parties may be provided with the option to rate each other (Step 562) through the system, and such ratings may be stored in database 104. The process concludes once ratings are received or after the parties decline to rate one another. The system can also be configured using computer-executable instructions, such as program modules, to transmit a second representation of the anonymous, semi-sealed bid reverse best-value online auction, either at a later point in the auction or once all bids are received and the auction ends, to one or more of the bidder computing devices 106/110/112. The second representation can include at least one winning bid amount associated with a winning bidder corresponding to an assigned identifier. Receipt of the second representation by the remote computing devices can trigger or cause at least one of the remote computing devices to display at least a portion of the information related to this second representation. The second representation may additionally or alternatively include one or more of the different identifiers relating to a second (e.g., later or end) status of the reverse auction, the randomly assigned ID numbers assigned to the bids/bidders, the number thereof, the timing thereof, etc. The information or image data relating to the first or second representations may be displayed using bitmap representation, or any other known technique for displaying image data.

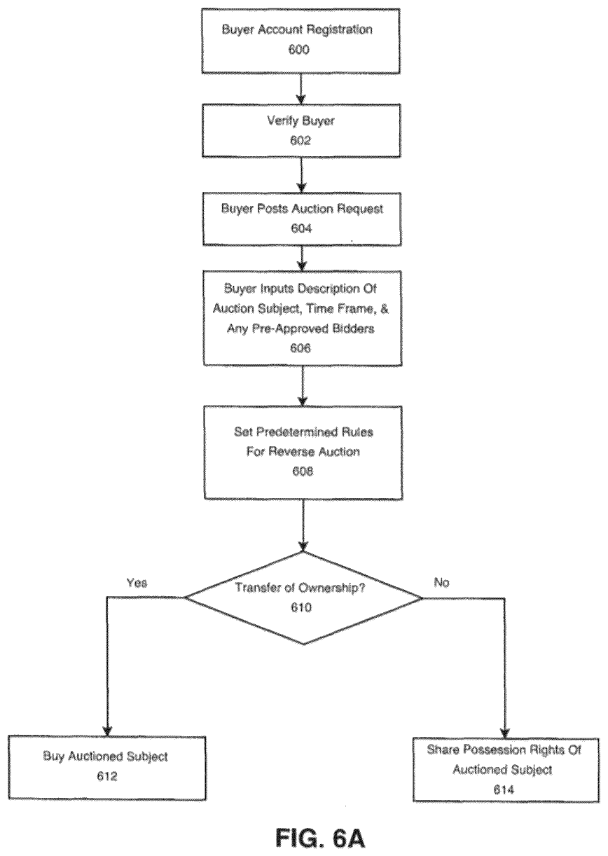

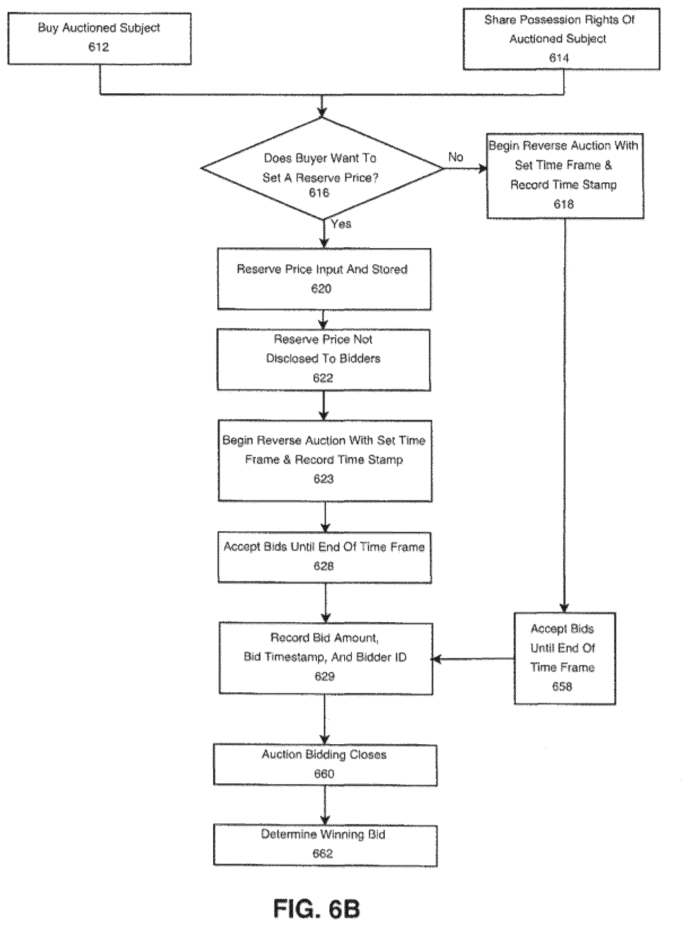

Turning next to FIG. 6A, illustrated is a flowchart depicting a bidding process from the buyer's side in accordance with an exemplary embodiment of the invention. As shown, buyers may register an account with the system (Step 600). Before setting up the details of the reverse auction, the buyer will be subject to account verification (Step 602), which may include background check, credit history check, review of auction history, reference check, double confirmation that he/she can and will make proper payment upon receipt of the goods/services desired, etc. After verification by the system is complete, the buyer may post a reverse auction request (Step 604). When beginning the process of setting up a reverse auction, the buyer may be prompted to input a description/introduction of the auction subject with a written description, photos, videos, etc., explaining the (good(s) and/or service(s) sought), the desired time frame for the reverse auction (e.g., from start to end), whether there are any pre-approved bidders, etc. (Step 606). This description/introduction may include any requirements, preferences, and/or conditions precedent to service the buyer has regarding the auction subject, such as, for example, the time frame needed for delivery and/or completion of the good(s) and/or service(s), the total number of products or services requested, the quality needed (e.g., specifying any applicable standards or reference materials in a particular industry pertaining to quality, referring to exemplary photographs, dimensions, etc.). The buyer may also indicate any requirements of the bidders themselves and who is qualified to bid. Such requirements may include, for example, fluency in a particular language, prior experience level, equipment requirements, licenses, skill level, citizenship, geographic location, etc. The system may be configured to enable questions and answers between a buyer and bidders before the reverse auction starts, and may make such questions and answers public to all auction participants via the computing devices. The buyer should provide any auction subject details needed to clarify or avoid confusion as to the requirements of the auction subject. The system can allow the buyer to preset the timeframe for the reverse auction and track the reverse auction until the end or close thereof.

The buyer can then establish predetermined rules for the auction, such as, for example, setting a reserve price. The buyer can also specify whether the reverse auction will involve a good/service that will involve one or more transfers of ownership (Step 610). If the reverse auction will involve a transfer of ownership (Yes, Step 610), then the buyer intends to buy rather than share possession rights of the auctioned subject (Step 612). If the reverse auction does not involve a transfer of ownership (No, Step 610), then the buyer intends to share possession rights for the auctioned subject for a specified period of time (Step 614).

As shown in FIG. 6B, once the buyer decides whether the auction subject will involve a transfer of ownership (Steps 610, 612, 614), the buyer may be prompted to set up a reserve price (Step 616). The reserve price is preferably the maximum amount that the buyer is willing to pay for the auction subject. In one embodiment, the reserve price is preset by the buyer and is not disclosed to any potential or actual bidders. In other embodiments, the reserve price may be disclosed to bidders before, during, or after the end of the reverse auction. The reserve price is set by the buyer at his/her discretion. In preferred embodiments, if the final amount of the winning bid.

The reserve price is preferably a maximum price, hidden (or closed) from bidders, representing the most a buyer is willing to pay for an auctioned good/service (i.e., an auction subject). In a reserve price reverse auction, the buyer is only obligated to buy the good/service if the winning bid amount is at or below the reserve price. It will be appreciated that a downside of a hidden reserve price is that a failed reverse auction may occur more frequently because the bidder-sellers may bid too high relative to the reserve price. Setting a hidden reserve price is preferably at the buyer's discretion, but may be automatically preset by the system by, for example, determining automatically a fair market value for the good/service being sought. In these embodiments, the bidders are not aware of the maximum amount a buyer is willing to pay for the auction subject. Such embodiments can offer a bottom up bidding approach in that they encourage bidders to bid up from a start auction price irrespective of the hidden reserve price meaning that the bidding amount can be higher or lower than the reserve price. In alternative embodiments, the reserve price may be conditionally hidden at the buyer's discretion. A conditional hidden reserve price auction as contemplated herein is one in which the system allows the buyer to optionally terminate the reverse auction early as soon as at least one bid is at or below the reserve price. The system can alternatively allow the bids to be accepted by a buyer even if the they are not equal to or below the conditional hidden reserve price set by the buyer.

Alternatively, a buyer may choose to use an open reserve price, which is a reserve price that is visible to the bidders during the reverse auction. In these embodiments, the bidders are aware of the maximum amount a buyer is willing to pay for the auction subject and offers a top down bidding approach in that it requires the bidders to bid down from the known reserve price, or to not participate in the auction at all. Such an open reserve auction may benefit savvy bidders in situations where a less savvy buyer sets a reserve price much higher than a market value for a particular good/service. Therefore, it will be appreciated that having an open versus hidden reserve auction has both pros and cons to the buyer and bidders. While having an open reserve auction will likely ensure that an auction does not fail even if there is only one bidder, it leaves open the possibility for savvy bidders to take advantage of less savvy buyers. For the bidders, an open reserve auction it enables them to offer bids that they know will be at an amount that the buyer may accept. It is also contemplated that the system may allow the bids to be accepted even if the they are above the hidden reserve price set by the buyer.

The buyer may also be prompted to input a start price for the auction. The start price is a preset amount which serves as a means for getting the reverse auction bidding started. It is open to (or visible by) the bidder-sellers, and may represent a maximum amount the buyer is willing to pay for the auctioned subject. A nominal price may be used as the start price to begin the bidding at an auction. As the buyer desires a low price, the start price might not have any relationship at all to the buyer's actual perceived value of the auction subject, and the winning bid may be above, below, or equal to the start price.

If the buyer chooses not to set up a reserve price (No, Step 616), then she/he may be prompted to set up the time frame for the reverse auction, including the start time and the end time and any other parameters for the auction (Step 618). The system can record a timestamp for the reverse auction listing with the unique index number to identify different listings. Once the time frame begins, the system then accepts bids (Step 658) until the timeframe ends and the reverse auction closes (Step 660). The system then records timestamps for bids received during the auction time frame (Step 629). Once the reverse auction closes, the system processes all of the accepted bids, the auction ends (Step 660), and the system determines the winning bid (Step 662).

If the buyer does set up a reserve price (Yes, Step 616), then the buyer may be prompted to input a reserve price that is stored in the database (Step 620), which, in preferred embodiments, the reserve amount is not disclosed to bidders even though the bidders are made aware of the existence of a hidden reserve price at the beginning of the auction in order to avoid any confusion (Step 622). The system then begins the reverse auction with a set time frame and records a time stamp for the auction beginning (Step 623), starts accepting bids from bidders (Step 628), and records timestamps for bids received during the auction time frame (Step 629). Before the reverse auction request is officially listed in the online auction platform, the system can issue an index number for each listed reverse auction request or auctioned subject, and can issue or record a timestamp corresponding to the start time of the reverse auction. If at the close of the auction the reserve price is exceeded by all of the bids, then the reverse auction is subject to potential termination depending on terms preset by the buyer. The system continues to accept bids from bidders until the reverse auction closes or ends (Step 660). Once the reverse auction closes, the system processes all of the bids received to select or determine the winning bid (Step 662), and checks to see if the winning bids exceed the reserve price.

Once bids have been accepted by the system and the auction closes or ends (Step 660, FIG. 6B), the system selects or recommends bids (Step 662) for final selection of one or more winners by the buyer. The winning bids selected will preferably be the best-value bids received, but can be preset by the buyer in advance of the auction in the form of a ranking (e.g., the number and quality of reviews). The system, buyer, or a third-party may establish, before a start of the auction and based on a set of predetermined rules, a ranking corresponding to which bid of the sealed bids will be recommended for consideration as the winning bids (i.e., the recommended bids will correspond to the lowest bids and highest value). For example, the buyer may want a bid other than the lowest bid to win, and can indicate this in the auction request she/he submits to the system. In other embodiments, the ranking corresponding to which bid of the one or more sealed bids selected as the winning bid can be established by the system by default.

Once the reverse auction is complete, the winning bidders provide the auction subject for the final bid amounts plus applicable additional costs, if any. The buyer then pays for the auctioned subject, which can be done before or after the bidder-seller provides the auction subject. Optionally, both parties can then rate one another and the overall transaction ends.

In a reverse auction, it is possible for there to be more than one identical winning bids at the close of the reverse auction. Referring to FIG. 6B, shown is a flowchart depicting a process of determining the final winning bidder when there are more than one identical best-value winning bids from more than one bidder in the same or different categories. As shown, in a preferred embodiment, after the reverse auction closes, the system identifies the lowest bid amount, and determines whether there are more than one identical bids at this best-value bid amount. If there are no identical best-value bid amounts, then the system chooses the best-value bids as the recommended bids. However, if the buyer desires a different ranking to be the winning bid in advance of the reverse auction (e.g., second lowest, third lowest, etc.), then he/she can input this setting in advance of the reverse auction, and the system can select the appropriate bids for consideration and final selection by the buyer.

If there are two or more identical bids for the recommended winning bid amounts, then the system can prompt the bidders to re-submit the bids within a predetermined timeframe. If the bidders re-submit bids, then the lowest re-submitted bids win the recommendation for the reverse auction. If the bidders re-submit identical bids again, the process can repeat itself until it determines a lowest re-submitted bid. Alternatively, the system may determine a maximum number of re-submissions allowed before canceling the auction or determining the first bidder to have submitted the initial bid to be the winning bid.

If the bidders choose not to re-submit the bids within the predetermined timeframe, then the bidder who was first to submit the original bid in the previous round first wins the recommendation. Once the winning bids, and by extension, the winning bidders, are selected, the winning bidders can provide the auction subject to the buyer, and the buyer is obligated to pay the winning bidders the final amount of the winning bid.

It will also be appreciated that certain sealed bid reverse online auctions may not sufficiently attract enough bidders to participate even if incentives are provided. Occasionally, only one bidder may bid in such a reverse auction. In these scenarios, if there is a sole bidder, then the bidder is not competing against any other bidders, and will win the reverse auction so long as the bid is at or below any maximum reserve price. Alternatively, the system may be configured to allow the reserve price to be used as the next lowest bid or the auction can be deemed a failure based on predetermined rules.

The systems and methods described herein may be executed on a computing device and/or computer system, generally comprised of a central processing unit (CPU) that is operatively connected to a memory device, data input and output circuitry (JO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the JO circuitry or the data communication circuitry. The data stored in memory may be further recalled from the memory device, further processed or modified by the CPU in the manner described herein and restored in the same memory device or a different memory device operatively connected to the CPU, including by means of the data network circuitry. The memory device can be any kind of data storage circuit or magnetic storage or optical device, including a hard disk, optical disk or solid-state memory. Examples of well-known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

Computer program logic implementing all or part of the functionality previously described herein may be embodied in various forms, including, but in no way limited to, source code, computer executable, and various intermediate forms (e.g., forms generated by an assembler, compiler, linker, or locator). Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages and may be in computer executable form (e.g., via an interpreter), or may be converted (e.g., via a translator, assembler, or compiler) into computer executable form.

The invention may be described in the general context of computer-executable instructions, such as program modules, being executed by a computer. Program modules include routines, programs, objects, components, data structures, etc., that perform particular tasks or implement particular data types. The computer program and data may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device, in any form in a signal that is transmittable to a computer using any of various communication technologies (e.g., analog technologies, digital technologies, optical technologies, wireless technologies, networking technologies, and internetworking technologies).

The invention may also be practiced in distributed computing environments where tasks are performed by remote processing devices that are linked through a communications network, and where program modules may be located in both local and remote computer storage media including memory storage devices. Practitioners of ordinary skill will recognize that the invention may be executed on one or more computer processors that are linked using a data network, including, for example, the Internet. Different steps of the process can be executed by one or more computers and storage devices geographically separated by connected by a data network in a manner so that they operate together to execute the process steps. A user's computer can run an application that causes the user's computer to transmit a stream of one or more data packets across a data network to a second computer, referred to here as a server. The server, in turn, may be connected to one or more mass data storage devices where the database is stored.

The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer.

In order for users to participate in the online reverse auctions, they must register for an account with the system. As mentioned above, before registration is completed, a user can be presented with a user agreement with the relevant rules preset for all sellers and buyers prior to a reverse auction. Personal information collected may include, but is not limited to, name address, email, phone number, and financial information required to complete the registration process. A valid email and/or a valid phone number may be used for verification purposes by the system administrator. Exemplary embodiments of the system will allow each user to register only one account associated with one username by a valid email and/or phone number. An account may be used to either bid on or list a reverse auction. By only allowing one account per user, the system can help prevent fraud. The system can also require a genuine name, a genuine address and genuine financial information to fully register a user. Financial information required may include, but is not limited to, a debit card, a credit card, third-party payment systems, bank routing numbers, etc.

The term “system” herein refers to implementation through a combination of hardware and software that operates a portable computing device, which comprises various pre-programmed features combined and integrated with basic components including but not limited to one or more servers, databases, mobile end applications, web portals, network settings, etc. With the support of these components, the system provides the services through user interfaces, such as a website or a mobile application. In addition, the system may have more than one server that may be in a distributed structure with support from data centers that may be located anywhere around the world. These implementations may be communicatively linked and cross-platformed so that a user on a computing device may be provided with the relevant information. Features of the system can be implemented through computing devices that allows steps of the method to be processed and output by a processor.

Notifications may be sent by the system through the server to both buyer-computing devices and/or bidder-computing devices through emails, instant messages, voice messages, etc. when necessary to alert them of different occurrences, including but not limited to successfully submitted bids, relevant auction time frames, rejected bids, reverse auction wins, auction results, etc. The systems described herein are used to provide a platform to facilitate at least one or multi-sided matching reverse auction markets, where bidders may simultaneously bid on reverse auctions from one or multiple buyers and buyers may solicit to one or multiple bidders. Each transaction may be facilitated against a fee or commission. The system or the platform may charge a predetermined percentage of service fees for providing auction services.

It should be noted that the semi-blind reverse-bid auction model exemplified in the system and platform of the present invention can also be used in other applications including, but not limited to:
Job search platforms like Indeed™ where the candidate is provided with suggested salary ranges based on what current candidates are bidding and what previous candidates who were successfully hired accepted.
Freelance artists or contracted work where the rate is variable.
Business supplies.
Speaker honorariums.
PCR synthesis and other sub-contracted work in the medical profession.
Any circumstance in which you haggle like on Ali Baba™.
Collectibles like art, comics, coins where there is limited sales data.
IP licensing or other assets.
Digital and physical advertising placement (Instagram, billboards).
Google™ adwords, website traffic.
Hospital procedures.
Bank loans.
Dogs and stud services for dogs, cows, horses.
Dating.

It is to be understood that the phraseology or terminology employed herein is for purposes of description and not of limitation. Having described at least one of the preferred embodiments of the present invention with reference to the accompanying drawings, it is to be understood that such embodiments are merely exemplary and that the invention is not limited to those precise embodiments, and that various changes, modifications, and adaptations may be effected therein by one skilled in the art without departing from the scope or spirit of the invention as defined in the appended claims. Therefore, while the embodiments herein have been described in terms of preferred embodiments, those skilled in the art will recognize that the embodiments herein can be practiced with modification within the spirit and scope of the claims. Any exemplary embodiments described herein are merely illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims. The scope of the invention, therefore, shall be defined solely by the following claims. Further, it will be apparent to those of skill in the art that numerous changes may be made in such details without departing from the spirit and the principles of the invention.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. An auction system for use by users comprising:
at least one computer disposed in communication with at least one server computer over at least one network;
a platform, said platform hosted by the at least one server computer, said platform accessible via the at least one computer;
the platform providing users the option to bid on at least one auction;
wherein the at least one auction is a sealed bid reverse online auction;
wherein the platform is configured to accept bids from bidding users until the at least one auction closes by naming a winning bidder; and
the platform connecting the winning bidder to the seller for payment and transfer of a subject of the at least one auction.
